(19) United States
(12) Patent Application Publication
(10) Pub. No.: US 2004/0074983 A1
(43) Pub. Date: Apr. 22, 2004

(54) Injection valve for injecting fuel into the combustion chamber of an internal combustion engine

(76) Inventors: Wolfgang Scheibe, Ludwigsburg-Poppenweiler (DE); Horst Ressel, Winnenden (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/296,621

(22) PCT Filed: May 25, 2001
(86) PCT No.: PCT/EP01/05973

(30) Foreign Application Priority Data
May 26, 2000 (DE) 10026286.4

(51) Int. Cl. F02M 47/02

(52) U.S. Cl. 239/96; 239/88; 239/584; 239/533.9; 239/533.3

(57) ABSTRACT

The invention relates to an injection valve (1) for injecting fuel into the combustion chamber of an internal combustion engine. The injector needle (17) of the injection valve (1) is guided inside the housing in such a way that it can be displaced longitudinally with a shaft (19) in order to open and close the injection cross-sections. The injector needle (17) is actuated by the fuel pressure which acts upon the injector needle and by a closing spring (16) acting in the closing direction of the injector needle. The closing spring (16) is pre-compressed between abutments on the injector needle (17) and the housing and is situated on the perimeter of the injector needle in the area between the injector needle guide (26) and the valve seat (18). One advantage of said arrangement is the compact construction of the injection valve (1) and the low dead volume of the control chamber (11) on the reverse side of the injector needle.

The invention concerns an injection valve for injecting fuel into the combustion chamber of an internal combustion engine as provided in the Preamble to claim 1.

Such an injection valve is assumed to be known, for example, from U.S. Pat. No. 5,832,899. The housing of the injection valve consists of a nozzle part with an injection opening and a nozzle holder, on which the nozzle part is attached with a threaded bush. A longitudinally movable guided nozzle needle is accommodated in a bore of the nozzle part. Clamped between the nozzle holder and the nozzle part is an insert, which delimits on one side a control chamber in which the nozzle needle is located with its rear end facing away from the injection holes. On the opposite side, the insert has a discharge outlet, which is connected to the control chamber via a central bore and a discharge throttle. The control chamber is connected via an intake throttle to a fuel channel, which conducts fuel under pressure toward a nozzle chamber located ahead of the injection holes. The fuel pressure acting on the back of the nozzle needle when the discharge opening is closed holds the nozzle needle with a valve closing spring on a valve seat in the nozzle part, so that no injection occurs. If the discharge opening controlled by the control valve is released, the fuel pressure in the control chamber drops, and the nozzle needle lifts from its valve seat due to the fuel under injection pressure acting on the front of the nozzle needle. A disadvantage of the illustrated injection valve is that a large dead volume is formed by the closing spring located in the control chamber, which acts on the back of the nozzle needle. The reaction of the injector to the switching signals, however, is dependent upon the size of the dead volume of the control chamber. If, for example, an injection is to be initiated, then the dead volume must first be released, for which a time period is necessary, which increases the reaction time of the injection start with respect to the control signal. Inversely, the dead volume also causes an extension of the reaction time when the injection valve is closed to conclude the injection. Long reaction times affect the accuracy of the injection and worsen the suitability of the injector for the pilot injection.

It is an object of the invention to specify a closing spring arrangement with a simple construction which, on the one hand, allows a compact design of the injection valve and, on the other hand, makes possible short reaction times to switching signals.

The object of the invention is attained in that the closing spring is provided on the periphery of the nozzle needle below the nozzle needle guide outside of the control chamber.

This arrangement of the closing spring allows a compact design of the injection valve without having to tolerate a complicated construction. In a preferred embodiment, the face of a guide sleeve serves as abutment for the closing spring on the side of the housing. The nozzle needle is advantageously configured with a surrounding groove, in which an inwardly resilient pre-tensioned ring is locked, on which the spring plate of the closing spring can be supported.

An exemplary embodiment of the invention is explained with reference to the drawings, characterized in that:

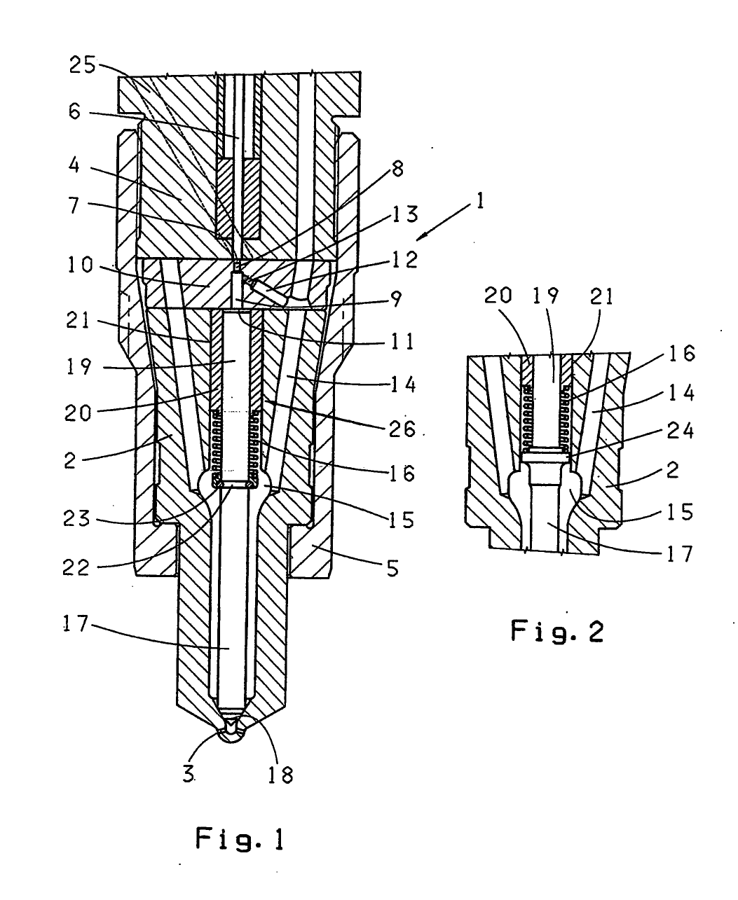

FIG. 1: shows a longitudinal section through the injection valve in accordance with the invention in the area of the nozzle part, and

FIG. 2: shows a nozzle needle with a molded edge as abutment.

FIG. 1 shows a longitudinal section of an injection valve 1 in the area of the nozzle part 2. The nozzle part 2, which contains the injection holes 3, is attached with the aid of a threaded bush 5 on the nozzle holder 4, which is not shown in its entirety. A nozzle needle 17 is guided in an axial motion into the nozzle part 2. The nozzle needle 17 is placed with a nozzle needle shaft 19 in a guide sleeve 20, which forms a guide 26, which in turn is arranged in a housing bore 21 of the nozzle part 2. The nozzle holder 4 contains an electromagnetic control valve, which is not shown and whose anchor is connected to a control element 6. The control element 6, which is also shown only partially, can be designed in the form of a rod, whose face, as shown, co-acts with a discharge opening 7. The discharge opening 7 is connected to a control chamber 11 via a closing throttle 8 and a bore 9 in an insert 10 between the nozzle holder 4 and the nozzle part 2. The control chamber 11 is connected via another bore 12 and an intake throttle 13 to a fuel intake channel 14, via which the fuel, which is under the injection pressure, is fed to a nozzle antechamber 15, which is accommodated ahead of the injection holes 3. The nozzle needle 17 is held against the valve seat 18 in the nozzle part 2 due to the fuel pressure existing when the drainage opening 7 in the control chamber 11 is closed, and therefore due to the fuel pressure acting on the back of the nozzle needle and also the pre-tensioned closing spring 16 acting in the closing direction, so that no injection takes place. If the control element 6 is pulled back and the discharge opening 7 is released, the pressure in the control chamber 11 drops. The fuel flowing through the discharge opening 7 reaches the return flow channel 25 shown with dashed lines. The speed with which the pressure drop for opening and the pressure increase for closing the injection valve takes place in the control chamber 11 should be as high as possible to facilitate a fast reaction of the injection valve 1 to the switching signals. This assumption is provided in that the control chamber 11 remains free of built-in components and therefore has a small dead volume, which is made possible by the arrangement of the closing spring 16 on the nozzle needle periphery. At the same time, the arrangement of the closing spring 16 on the periphery of the nozzle needle 17allows a simple construction of the injection valve 1, so that a particularly compact design is possible.

The abutments required for supporting the closing spring 16 are formed by the guide sleeve 20 of the nozzle needle shaft 19 on the side of the housing in accordance with FIG. 1. In this way, the closing spring 16 is supported on a face of the guide sleeve 20. The abutment can be formed on the side of the nozzle needle, for example, by a peripheral groove 22 and a radially inwardly resilient spring 23 locked therein. As shown in FIG. 2, it is also possible to configure the abutment on the nozzle needle 17 via an edge 24 formed as one piece with the nozzle needle 17.

1. Injection valve (1) for injecting fuel into the combustion chamber of an internal combustion engine, with a housing; a nozzle needle (17), which is mounted in the housing so as to be longitudinally movable with a nozzle needle shaft (19) in a guide (26) and co-acts at one end of a valve seat (18) in the sense of an opening and closing of an injection cross section of the housing; a nozzle antechamber (15) arranged ahead of the nozzle needle shaft (19) on the side of the valve seat, which is connected to a fuel feeding channel (14) for supplying fuel to be injected under pressure; a control chamber (11) coupled to a nozzle needle (17), which can be impinged by the fuel under pressure and which can be released of pressure by means of a control element (6) coupled to a control valve in the sense of an opening of the nozzle needle (17); and with a closing spring (16), which can impinge on the nozzle needle (17) in the closing direction, which co-acts with abutments on the nozzle needle (17) and housing, characterized in that the closing spring (16) is arranged in the area between the nozzle needle shaft (19) and the valve seat (18) on the periphery of the nozzle needle (17).

2. Injection valve according to claim 1, characterized in that the housing of the injection valve (1) is configured with a separate nozzle part (2) attached on the nozzle holder (4), and characterized in that the nozzle part (2) comprises the guide (26) of the nozzle needle shaft (19).

3. Injection valve according to claim 1 or 2, characterized in that the nozzle needle (17) is located in the control chamber (11) with its rear end facing away from the valve seat (18).

4. Injection valve according to claim 1, 2 or 3, characterized in that the control valve is arranged above the control chamber (11) in the nozzle holder (4) and controls a discharge opening (7) connected to the control chamber (11) with the control element (6).

5. Injection valve according to claim 4, characterized in that a plate-shaped insert (10) is provided between the nozzle part (2) and the nozzle holder (4) which, on the one hand, comprises the discharge opening (7) and, on the other hand, serves as an end stop for the nozzle needle (17).

6. Injection valve according to one of the claims 1 to 5, characterized in that the nozzle needle (19) is guided in a guide sleeve (20), which is located in a housing bore (21), and characterized in that a face edge of the guide sleeve (20) facing away from the control chamber (11) serves as an abutment for the closing spring (16) on the side of the housing.

7. Injection valve according to one of the claims 1 to 6, characterized in that a peripheral edge (24) serves as an abutment on the side of the nozzle needle connected to the nozzle needle (17).

8. Injection valve according to claim 7, characterized in that the edge (24) is configured as one piece with the nozzle needle (17).

9. Injection valve according to claim 7, characterized in that the edge (24) is formed by a ring (23) attached on the nozzle needle (17).

10. Injection valve according to claim 9, characterized in that the ring (23) is placed under radial pretension in a groove (22) of the nozzle needle (17).
